(19) United States
(12) Patent Application Publication
(10) Pub. No.: US 2010/0328698 A1
(43) Pub. Date: Dec. 30, 2010

(54) JOB PROCESSING APPARATUS THAT REALIZES NOTIFICATION APPROPRIATE TO INTENTION OF USER AND USAGE ENVIRONMENT, CONTROL METHOD FOR THE JOB PROCESSING APPARATUS, AND STORAGE MEDIUM

(75) Inventor: Hiroyuki Toriyabe, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/818,513

(22) Filed: Jun. 18, 2010

(30) Foreign Application Priority Data
Jun. 24, 2009 (JP) 2009-149793

(51) Int. Cl. G06F 3/12

(52) U.S. Cl. 358/1.14

(57) ABSTRACT

A job processing apparatus that enables a user to change conditions for determining whether or not there is a high possibility that a job processing result will not be normal, and thus realizes notification appropriate to user's intentions and usage environment. When a job is to be executed, it is determined whether or not predetermined conditions will be satisfied by executing the job. When it is determined that the predetermined conditions will be satisfied by executing the job, the user is notified that there is a high possibility that an image will not be correctly printed. The predetermined conditions are changed in accordance with an instruction received from the user.

### BACKGROUND OF THE INVENTION

1. Field of the Invention

The present invention relates to a job processing apparatus, a control method for the job processing apparatus, and a non-transitory computer-readable storage medium storing a program.

2. Description of the Related Art

Conventionally, there have been job processing apparatuses such as printing apparatuses which notify a user of an error when it is determined that execution of a job will be discontinued due to a shortage of resources required to execute the job (see Japanese Laid-Open Patent Publication (Kokai) No. 2007-326269). Such job processing apparatuses determine whether or not to execute a job by comparing job processing conditions such as a sheet size and a finishing process with resource information such as remaining amounts of resources (such as sheets and staples) which the job processing apparatuses have. When it is determined that a job cannot be executed according to conditions designated in the job processing conditions, a user is notified of an error.

However, in the conventional method, whether or not to execute a job is determined, but whether or not a job processing result will be normal is not determined. For example, even when it is possible to complete processing of a job because there are sufficient resources required to execute the job, a job processing result may be abnormal depending on job execution conditions. In such a case, a user cannot be notified of this.

Moreover, in the conventional method, a user cannot change conditions for receiving notification according to circumstances such as user's intentions and usage environment.

For example, a user may want to tighten conditions and thus inhibit job processing results from becoming abnormal so as to improve qualities of job processing results. Also, a user may want to loosen conditions so as to maintain high operation rates of a job processing apparatus when he/she wants to place emphasis on job processing efficiency.

### SUMMARY OF THE INVENTION

The present invention provides a job processing apparatus that enables a user to change conditions for determining whether or not there is a high possibility that a job processing result will not be normal, and thus realizes notification appropriate to user's intentions and usage environment, a control method for the job processing apparatus, and a computer-readable storage medium storing a program.

Accordingly, in a first aspect of the present invention, there is provided a job processing apparatus comprising a determination unit adapted to, when a job is to be executed, determine whether predetermined conditions will be satisfied by executing the job, a notification unit adapted to, when the determination unit determines that the predetermined conditions will be satisfied by executing the job, notify a user that there is a high possibility that an image will not be correctly printed, and a control unit adapted to change the predetermined conditions in accordance with an instruction received from the user.

Accordingly, in a second aspect of the present invention, there is provided a control method for a job processing apparatus, comprising a determination step of, when a job is to be executed, determining whether predetermined conditions will be satisfied by executing the job, a notification step of, when it is determined in the determination step that the predetermined conditions will be satisfied by executing the job, notifying a user that there is a high possibility that an image will not be correctly printed, and a control step of changing the predetermined conditions in accordance with an instruction received from the user.

Accordingly, in a third aspect of the present invention, there is provided a non-transitory computer-readable storage medium storing a program for causing a computer to execute a control method for a job processing apparatus.

According to the present invention, because a user can change conditions for determining whether or not there is a high possibility that a job processing result will be not normal, notification of a warning or the like appropriate to user's intentions and usage environment can be realized.

Further features of the present invention will become apparent from the following description of exemplary embodiments (with reference to the attached drawings).

### BRIEF DESCRIPTION OF THE DRAWINGS

FIG. 1 is a block diagram useful in explaining an exemplary arrangement of a printing apparatus according to a first embodiment of the present invention.

FIG. 2 is a schematic cross-sectional view useful in explaining an exemplary structure of the printing apparatus.

FIG. 3 is a view useful in explaining an exemplary arrangement of an operation display unit.

FIG. 4 is a view showing an exemplary layout of a warning determination level setting screen displayed in a touch panel portion of the operation display unit.

FIG. 5 is a view showing another exemplary layout of the warning determination level setting screen displayed in the touch panel portion of the operation display unit.

FIG. 6 is a view showing an exemplary layout of a warning notification setting screen displayed in the touch panel portion when a warning notification setting button in the touch panel portion is operated.

FIG. 7 is a flowchart useful in explaining an exemplary operation of a printing apparatus according to a third embodiment of the present invention.

FIG. 8 is a view showing an exemplary layout of a warning screen displayed in the touch panel portion when it is determined that there is a high possibility that an abnormal event will occur.

FIG. 9 is a flowchart useful in explaining a process in a case where job information as well as a status of the printing apparatus and job properties is used in determining whether or not there is a high possibility that an image defect will occur.

FIG. 10 is a flowchart useful in explaining an exemplary operation of a printing apparatus according to a second embodiment of the present invention.

### DESCRIPTION OF THE EMBODIMENTS

The present invention will now be described in detail with reference to the drawings showing embodiments thereof.

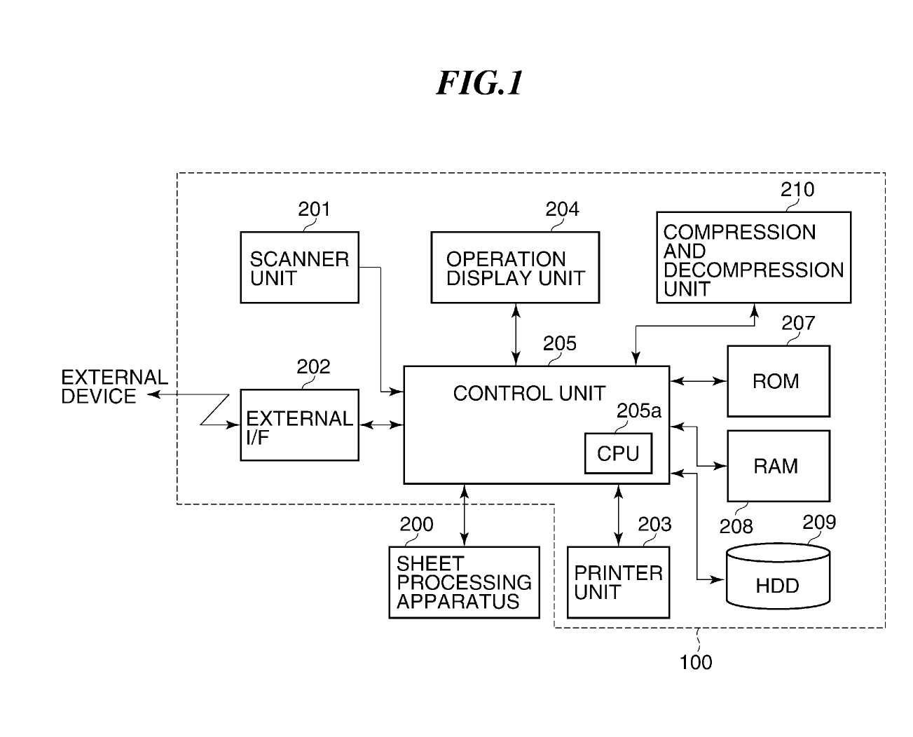

FIG. 1 is a block diagram useful in explaining an exemplary arrangement of a printing apparatus which is a first embodiment of a job processing apparatus according to the present invention.

Referring to FIG. 1, the printing apparatus 100 according to the present embodiment has a scanner unit 201, an external I/F 202, a printer unit 203, an operation display unit 204, a control unit 205, a ROM 207, a RAM 208, an HDD 209, and a compression and decompression unit 210.

A sheet processing apparatus 200 is connected to the control unit 205 of the printing apparatus 100 for communication therewith. Although in the present embodiment, an MFP having a plurality of functions such as a copy function and a printer function (MFP: multifunction peripheral) is taken for example as the printing apparatus 100, but the printing apparatus 100 may be an SFP having only a copy function or a printer function.

The scanner unit 201 reads an image of an original, converts the same to image data, and outputs the image data to the control unit 205. The external I/F 202 sends and receives data to and from an external device connected thereto via a network, not shown.

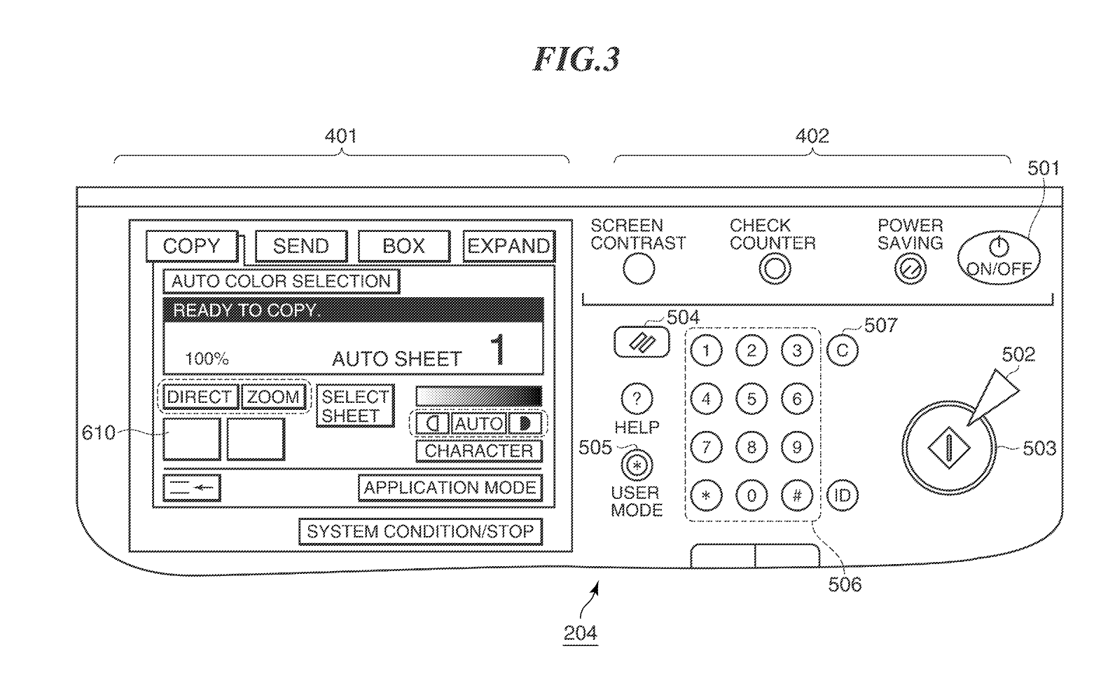

The printer unit 203 prints, on a sheet, an image based on input image data. The operation display unit (console) 204 has a key input portion 402 and a touch panel portion 401 that receive instructions from a user (FIG. 3).

The control unit 205 has a CPU 205a and plays a pivotal role in controlling the entire printing apparatus 100. The control unit 205 executes processing of jobs such as a copy job of causing the printer unit 203 to print an image of an original read by the scanner unit 201, and a print job of printing image data received from the external device in accordance with print settings received with the image data. Also, the control unit 205 executes a data sending job of sending image data of an original read by the scanner unit 201 to the external device. In accordance with instructions from the user via the operation display unit 204 or the like, the control unit 205 causes the printer unit 203 to print image data stored in the HDD 209, and send the same to an external device such as a server, not shown, via the external I/F 202. Also, the control unit 205 controls operation of the sheet processing apparatus 200 connected to the printing apparatus 100 in accordance with instructions from the user via the operation display unit 204 or the like.

The ROM 207 stores various programs to be executed by the control unit 205, display control programs required to display various setting screens on the operation display unit 204, a boot sequence, font information, and so on. Also, the ROM 207 stores a program for the control unit 205 to interpret PDL (page description language) code data received from a server, a client PC, or the like and expand the same into raster image data.

The RAM 208 stores image data sent from the scanner unit 201 and the external I/F 202, and various programs and setting information loaded from the ROM 207. Also, the RAM 208 stores information on the sheet processing apparatus 200 (such as the number of sheet processing apparatuses 200 connected to the printing apparatus 100, information on functions of each sheet processing apparatus 200, and an order in which the sheet processing apparatuses 200 are connected). Data is written into or read from the RAM 208 under the control of the CPU 205a of the control unit 205.

The HDD 209 is a large-capacity storage device for storing image data input from the scanner unit 201 and the external I/F 202 and compressed by the compression and decompression unit 210.

The compression and decompression unit 210 carries out compression and decompression of image data or the like stored in the RAM 208 and the HDD 209 using various compression methods such as JBIG and JPEG.

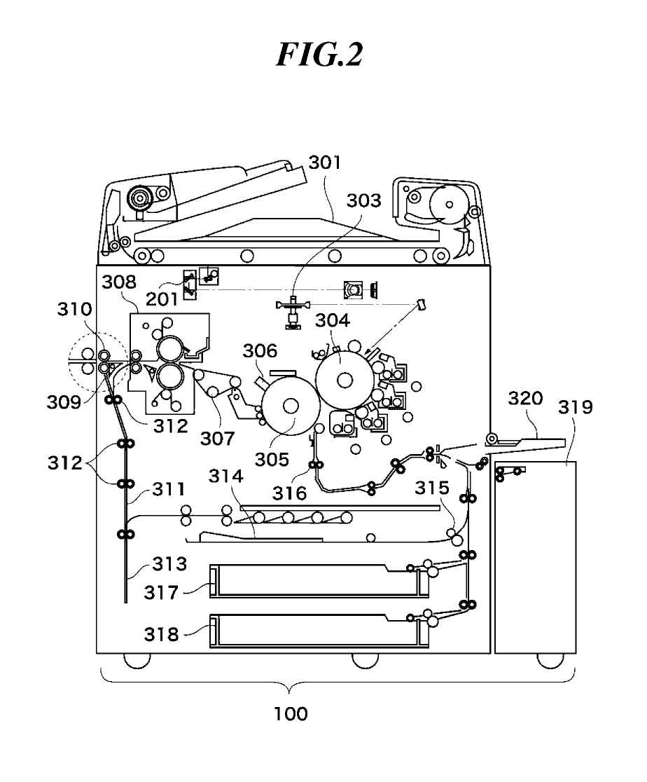

Referring next to FIG. 2, a description will be given of an exemplary structure of the printing apparatus 100 according to the present embodiment.

Referring to FIG. 2, an automatic document feeder (ADF) 301 separates a bundle of originals set on an original tray sequentially in page order from a top page, and feeds each original onto an original platen glass. The scanner unit 201 reads an image of an original fed onto the original platen glass and converts the image into image data using a CCD.

Laser light modulated according to the image data obtained by the conversion incidents upon a rotary multi-part mirror (such as a polygon mirror) 303. Then, the rotary multi-part mirror 303 irradiates the incident laser light as reflected scanning light onto a photosensitive drum 304 via a reflection mirror to form a latent image on the photosensitive drum 304.

The latent image formed on the photosensitive drum 304 is developed by toner, and a toner image is transferred onto a sheet attached to a transfer drum 305. This image formation sequence is carried out in order with respect to yellow (Y), magenta (M), cyan (C), and black (K) toners, whereby a full-color image is transferred to the sheet.

The sheet on the transfer drum 305 to which the full-color image has been transferred as described above is separated from the transfer drum 305 by a separation nail 306, and conveyed to a fixing unit 308 by a pre-fixing conveying unit 307.

The fixing unit 308 is comprised of a combination of rollers, belts, and so on, and has a heat source such as a halogen heater incorporated therein. The fixing unit 308 melts and fixes toner on a sheet, to which a toner image has been transferred, by heat and pressure.

A sheet discharging flapper 309 is constructed such as to be able to swing about a swing axis, and defines a direction in which a sheet is conveyed. When the sheet discharging flapper 309 is rotating clockwise as viewed in the figure, a sheet is discharged from the printing apparatus 100 by sheet discharge rollers 310. The control unit 205 controls the printing apparatus 100 to carry out one-sided printing through the above described sequence.

On the other hand, when images are to be formed on both sides of a sheet, the sheet discharging flapper 309 rotates counterclockwise as viewed in the figure to change the direction of the sheet downward, so that the sheet is fed to a double-sided conveying unit 311.

The double-sided conveying unit 311 has inversion rollers 312, an inversion guide 313, and a double-sided tray 314. To process a double-sided print job, the control unit 205 provides control to print an image on a first surface of a sheet the printer unit 203, and feed the sheet to the inversion guide 313 via the inversion rollers 312.

Then, the control unit 205 temporarily stops the rotation of the inversion rollers 312 with a trailing end of the sheet sandwiched between the inversion rollers 312, and then causes the inversion rollers 312 to rotate in a reverse direction. Thus, the sheet is controlled to be switched back and guided to the double-sided tray 314 with the trailing end and a leading end of the sheet reversed.

The sheet guided to the double-sided tray 314 is temporarily placed on the double-sided tray 314, and then fed to registration rollers 316 again by refeed rollers 315. At this time, the sheet is being conveyed in a state in which a surface thereof opposite to that during the transfer of the first surface faces the photosensitive drum 304.

Then, in a manner similar to that in the above described process, an image is transferred to the second surface of the sheet, and the sheet with the images formed thereon is subjected to the fixing process and discharged from the printing apparatus 100 via the sheet discharge rollers 310. The control unit 205 controls the printing apparatus 100 to carry out double-sided printing through the above described sequence.

Also, the printing apparatus 100 has sheet feeding units that store sheets required for printing. The sheet feeding units are comprised of sheet feeding cassettes 317 and 318, a sheet feeding deck 319, a manual feed tray 320, and so on. On the sheet feeding cassettes 317 and 318 and the sheet feeding deck 319, various sheets of different sizes which are made of different materials including tab sheets can be separately set in the respective sheet feeding units.

Also, various sheets including special sheets such as OHP sheets can be set on the manual feed tray 320. The sheet feeding cassettes 317 and 318, the sheet feeding deck 319, and the manual feeding tray 320 are each provided with sheet feeding rollers, and sheets are successively fed one by one through rotation of the sheet feeding rollers.

Referring next to FIG. 3, a description will be given of an exemplary arrangement of the operation display unit 204.

The operation display unit 204 has a touch panel portion 401 and a key input portion 402. The touch panel portion 401 has a liquid crystal display portion and a transparent electrode attached thereon, and displays various setting screens for receiving instructions provided by user's operations. The touch panel portion 401 has a function of displaying various screens, and an instruction inputting function of receiving instructions provided by user's operations.

The key input portion 402 has a power key 501, a start key 503, a top key 502, a guide key 504, a user mode key 505, and a numeric keypad 506. The start key 503 is used to cause the printing apparatus 100 to start executing a copy job or a sending job. The numeric keypad 506 is used to input numeric values such as the number of sheets to be printed.

The control unit 205 controls the printing apparatus 100 to carry out various types of processes based on user's instructions received via various setting screens displayed in the touch panel portion 401 and user's instructions received via the key input portion 402.

It should be noted that in the touch panel portion 401, there are displayed mode buttons for setting various operations modes such as copying, sending, box, and expansion, and various instruction buttons for setting printing magnifications and configuring sheet settings. These various instruction buttons are well known, and hence description thereof is omitted, and a description will be given of a case where a warning notification setting button 610 is operated (touched).

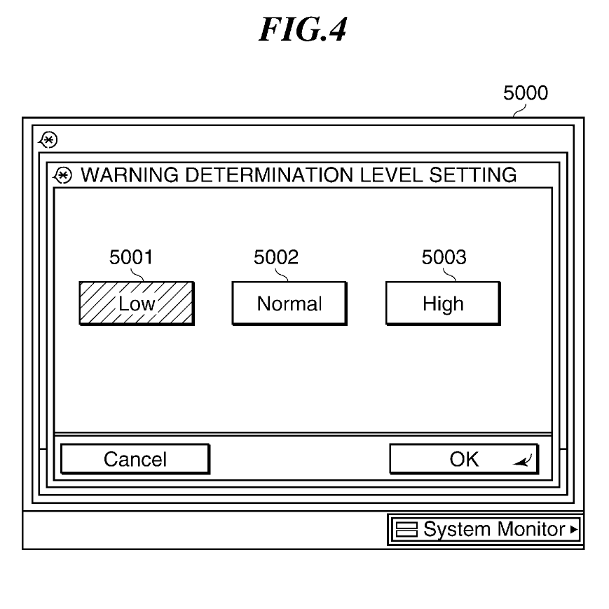

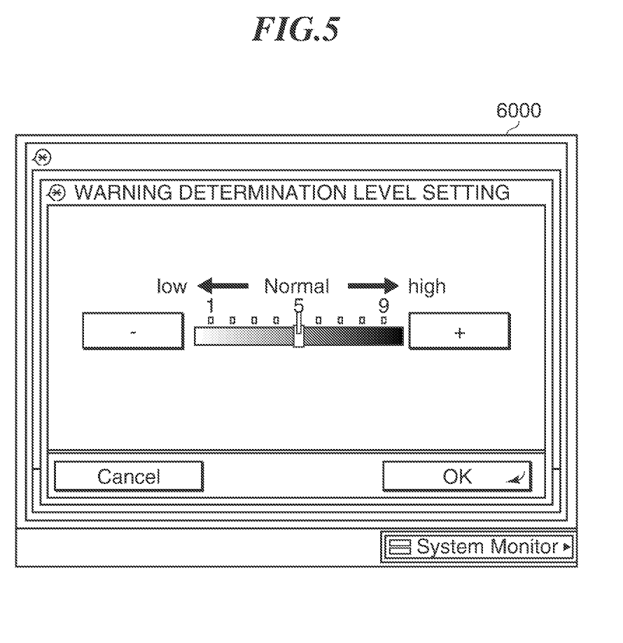

FIGS. 4 and 5 are views showing exemplary layouts of warning determination level setting screens 5000 and 6000 displayed in the touch panel portion 401 when the warning notification setting button 610 in the touch panel portion 401 is operated.

By selectively operating buttons (soft keys) displayed on the warning determination level setting screen 5000 or 6000, the user can select a warning determination level for the printing apparatus 100. When a low warning determination level is set, conditions for warning the user are loosened, and when a high warning determination level is set, conditions for warning the user are tightened. A concrete description thereof will be given later.

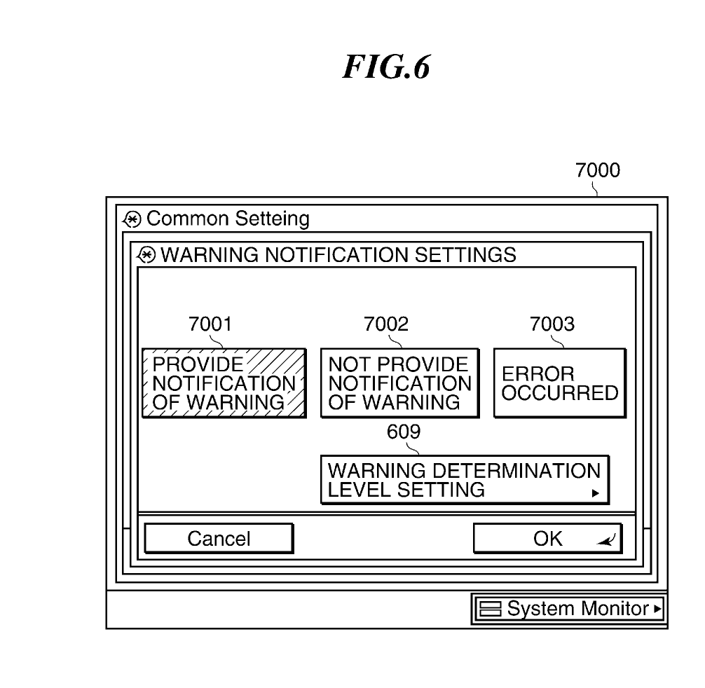

It should be noted that the warning determination level setting screens 5000 and 6000 may be displayed in the touch panel portion 401 when a warning determination level setting button 609 on a warning notification setting screen 7000 shown in FIG. 6 is operated.

FIG. 6 is a view showing an exemplary layout of the warning notification setting screen 7000 displayed in the touch panel portion 401 when the warning notification setting button 610 in the touch panel portion 401 is operated. When conditions corresponding to the warning determination level set in FIG. 4 or FIG. 5 are satisfied, a warning notification process set in FIG. 6 is carried out.

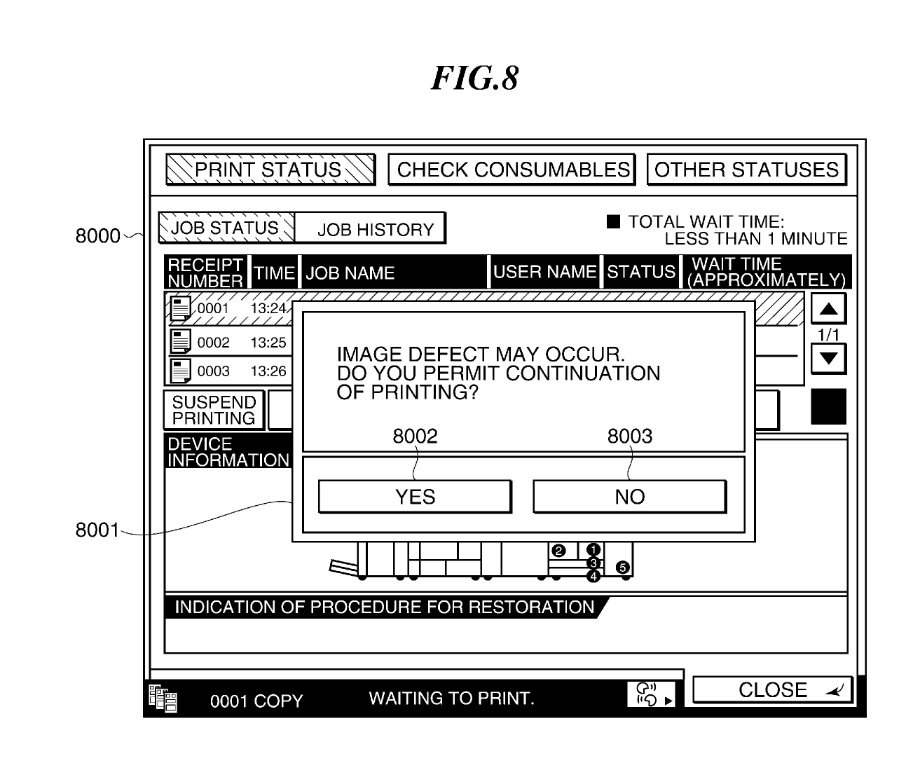

By selectively operating buttons (soft keys) displayed on the warning notification setting screen 7000, the user can select and set a type of the warning notification process in the printing apparatus 100. On the screen in FIG. 6, the user can selectively determine whether notification of a warning is provided, notification of a warning is not provided, or it is determined that an error occurred when conditions corresponding to the warning determination level set via the screen in FIG. 4 or FIG. 5 are satisfied. When a setting is made by a button 7001 so as to provide notification of a warning, the CPU 205a displays a screen as shown in FIG. 8 to give a warning when predetermined conditions (conditions corresponding to the warning determination level set in FIG. 4 or FIG. 5) are satisfied. Then, on the screen as shown in FIG. 8, the CPU 205a checks whether or not to continue printing. When “Yes” is selected so as to continue printing, the CPU 205a continues printing, and when “No” is selected so as to discontinue printing, the CPU 205a discontinues printing, and puts the job on hold in the HDD 209.

On the other hand, when a setting is made by a button 7002 so as not to provide notification of a warning, the CPU 205a does not provide notification of a warning even when the predetermined conditions are satisfied, and provides control to execute the job.

When a setting is made by a button 7003 so as to determine that an error occurred, the CPU 205a provides control to determine that an error occurred, and cause the HDD 209 to hold the job when the predetermined conditions are satisfied. The job held in the HDD 209 is canceled or re-executed separately in accordance with an instruction from the user.

It should be noted that when the predetermined conditions are not satisfied, the CPU 205a executes the job to carry out normal printing without giving a warning.

As described above, the CPU 205a determines whether or not a determination criterion value (condition) corresponding to a warning determination level value set by the user is met, and when it is determined that the determination criterion value is met, notification of a warning is provided to the user.

Next, a description will be given of a case where the user is warned, for example, that there is a possibility that a predetermined striped pattern will appear in an image.

The predetermined striped pattern means an image defect (abnormal event) occurring due to overflowing of a developer (toner) from a developing unit of the printing apparatus 100. In this case, an output image cannot be normally printed. The striped pattern appears when, for example, conditions 1 to 4 described below are satisfied. When the conditions 1 to 4 are satisfied, a developing agent cannot be uniformly ejected from a developer container, and the amount of ejected developer increases or decreases, resulting in appearance of the striped pattern.

Condition 1: The temperature of the drum is high. The drum operates normally at, for example, a temperature of 42.5 degrees. The condition 1 is satisfied when the temperature of the drum becomes equal to or higher than 45 degrees.

Condition 2: The toner-carrier ratio (TC ratio) of the developer is high.

Condition 3: The printing density is low.

Condition 4: A continuous long job in a black monochrome mode. It should be noted that the black monochrome mode means a mode in which printing is carried out using only black toner. It should be noted that the continuous long job means a job in which 10000 or more sheets are printed by executing the job. Namely, the condition 4 is satisfied when 10000 or more sheets are printed using only black toner. The CPU 205a can determine whether or not 10000 or more sheets will be printed by executing a job according to the number of pages in a job stored in the HDD 209 and settings received from the user. For example, when image data of 15000 pages is to be one-sided printed, the number of sheets to be printed will be 15000, and hence the control unit 205 determines that 10000 or more sheets will be printed. On the other hand, when image data of 15000 pages is to be double-sided printed, the number of sheets to be printed will be 7500, and hence the control unit 205 determines that 10000 or more sheets will not be printed.

Here, focusing attention to the condition 4, a similar image defect may occur on the following similar printing conditions similar to “a continuous long job in a black monochrome mode”:

Similar condition 1: A continuous long job in a color mode, the job in which toners of specific colors are not used (for example, a continuous long job in which cyan and magenta toners are used, but yellow and black toners are not used).

Similar condition 2: A continuous long job in a color mode, the job in which toners of all the colors CMYK are used, but a signal value of a single color or signal values of a plurality of colors are extremely small (for example, a continuous long job in which (C, M, Y, K)=(1%, 1%, 100%, 100%)).

Here, assume that a determination criterion value of the drum temperature in a case where the warning determination level is “Normal” is 45 degrees. Namely, assume that when the drum temperature is not less than 45 degrees, the CPU 205a determines that the above described condition 1 on which the predetermined striped pattern appears is satisfied.

When the user wants to loosen criteria for warning so as to prevent printing from being stopped due to a warning to the extent possible, and place emphasis on printing efficiency, he/she operates a Low button 5001 on the warning determination level setting screen 5000. When the Low button 5001 is operated, the CPU 205a provides control to change the determination criterion value of the drum temperature to 47 degrees based on the operating information.

On the other hand, when the user wants to tighten criteria for warning and place emphasis on image qualities of printed matter, he/she operates a High button 5003 on the warning determination level setting screen 5000. When the High button 5003 is operated, the CPU 205a provides control to change the determination criterion value of the drum temperature to 43 degrees based on the operating information.

As for a degree of change in the determination criterion value when the warning determination level is changed, although in the above described example, there is a difference of 5 degrees between the levels, the present invention is not limited to this, but a difference between levels may be 1 degree or 1% of the standard determination criterion value.

Moreover, although in the above described example, there are the three warning determination levels “Low”, “Normal”, and “High”, there may be nine warning determination levels 1 to 9 as shown in FIG. for selection by the user.

Further, although in the above described example, the CPU 205a changes the determination criterion value according to a warning determination level designated by the user, there may be provided a means for the user to directly set a concrete determination criterion value at, for example, 44 degrees. In this case, it can be considered that, for example, upper and lower limits to set values are provided in advance, and when the user sets a value beyond the upper and lower limits, the user is notified that the set value is invalid.

Further, although in the above described example, the CPU 205a provides control to notify the user of a warning when it is determined that there is a high possibility that an abnormal event will occur, the CPU 205a may prompt the user to select any other process.

For example, when the user operates a warning non-notification button 7002 on the warning notification setting screen 7000 shown in FIG. 6, the CPU 205a provides control so as not to notify the user of a warning when it is determined that there is a high possibility that an abnormal event will occur. Also, when the user operates an error button 7003 on the warning notification setting screen 7000, the CPU 205a provides control to determine that an error occurred without notifying the user of a warning when it is determined that there is a high possibility that an abnormal event will occur.

It should be noted that the user may be notified of not only a warning but also a cause of the warning notification.

For example, a description will be given by taking the above described predetermined stripe pattern for example. When notification of a warning is provided because the condition 4 i.e. “a continuous long job in a black monochrome mode” is satisfied, the CPU 205a may notify the user that the job is in a black monochrome mode and the number of sheets to be printed exceeds a reference value.

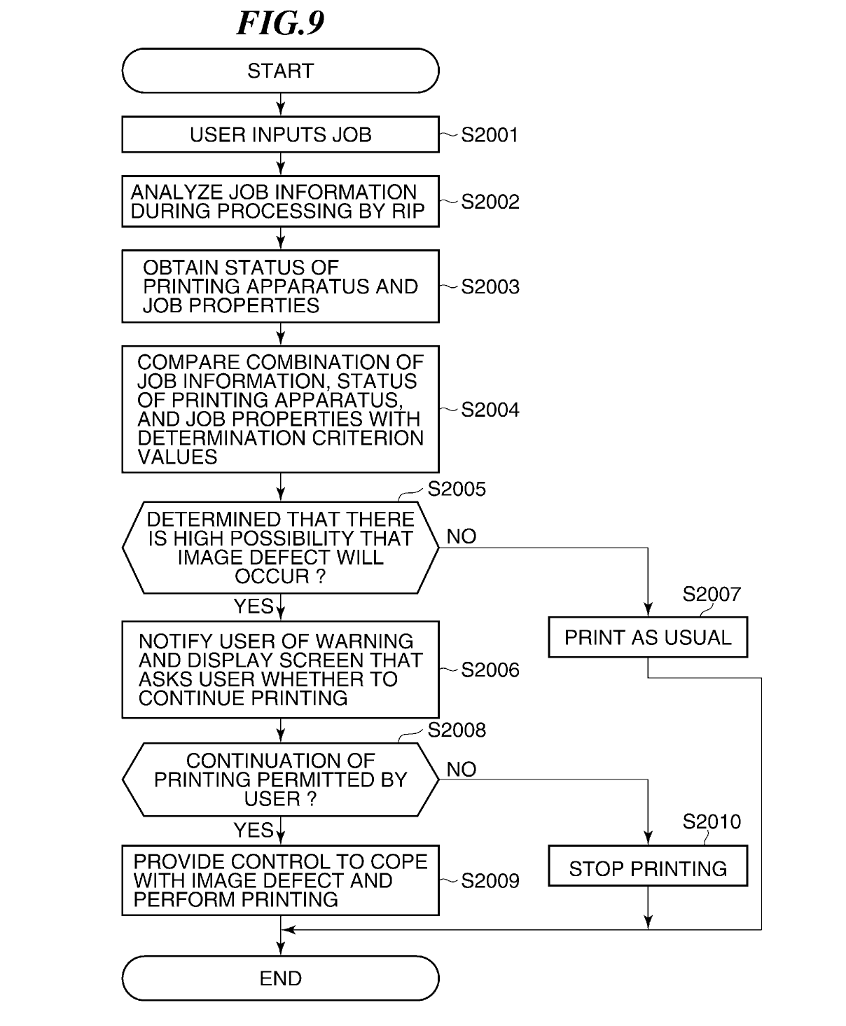

Referring next to FIG. 9, a description will be given of processes in a case where job information (information on usage of toner) as well as a status of the printing apparatus 100 and settings of a job is used in determining whether or not there is a high possibility that an image defect will occur. The job information is interpreted by an RIP (raster image processor) before inputted to the printing apparatus 100. Each of the processes in FIG. 9 is executed by the CPU 205a of the control unit 205 in accordance with a control program stored in the ROM 207, the HDD 209, or the like and loaded into the RAM 208.

In step S2001, the CPU 205a performs monitoring to check whether or not a printing request has been received. When a printing request has been received, the CPU 205a stores in the HDD 209 print data of a print job as an object to be executed, and proceeds to step S2002.

In the step S2002, during processing by the RIP, the CPU 205a analyzes job information to be inputted, and holds the same. The CPU 205a then proceeds to step S2003. Here, the job information means information on toners to be used. For example, the CPU 205a calculates the amount of each of CMYK toners to be used by counting based on video count values corresponding to image data of the job.

In the step S2003, the CPU 205a obtains a status of the printing apparatus 100 and job properties, and holds the obtained data. The CPU 205a then proceeds to step S2004.

In the step S2004, the CPU 205a compares a combination of the status of the printing apparatus, the settings of the job, and the job information analyzed in the step S2002 with determination criterion values, and proceeds to step S2005.

In the step S2005, based on the result of the comparison in the step S2004, the CPU 205a determines whether or not the above described conditions 1 to 4 (the similar condition 1 or 2 in place of the condition 4) are satisfied, and there is a high possibility that an image defect will occur. When determining that there is a high possibility that an image defect will occur, the CPU 205a proceeds to step S2006, and when not, the CPU 205a proceeds to step S2007.

In the step S2007, because it is determined that there is not a high possibility that an image defect will occur, the CPU 205a carries out normal printing, and terminates the process.

On the other hand, in the step S2006, because it is determined that there is a high possibility that an image defect will occur, the CPU 205a temporarily puts execution of the job on hold, and displays a warning screen 8000 and a printing continuation permission dialogue 8001 shown in FIG. 8 in the touch panel portion 401, and proceeds to step S2008.

In the step S2008, the CPU 205a determines whether or not the user has permitted continuation of printing based on information on a user's operation on the printing continuation permission dialogue 8001, and when permitted, the CPU 205a proceeds to step S2009, and when not, the CPU 205a proceeds to step S2010.

Here, when the user operates an “Yes” button 8002 on the printing continuation permission dialogue 8001, the CPU 205a determines that the user has permitted continuation of printing based on the operating information. Also, when the user operates a “No” button 8003 on the printing continuation permission dialogue 8001, the CPU 205a determines that the user has not permitted continuation of printing based on the operating information.

In the step S2010, because the user has not permitted continuation of printing, the CPU 205a stops printing, and terminates the process.

In the step S2009, because the user has permitted continuation of printing, the CPU 205a provides control to cope with an image defect, starts printing, and after completion of printing, terminates the process.

A description will now be given of control to cope with an image defect by taking the above described striped pattern for example.

The similar conditions 1 and 2 similar to the condition 4 i.e. “a continuous long job in a black monochrome mode” on which the above described striped pattern appears are shown below again.

Similar condition 1: A continuous long job in a color mode, the job in which toners of specific colors are not used.

Similar condition 2: A continuous long job in a color mode, the job in which toners of all the colors CMYK are used, but a signal value of a single color or signal values of a plurality of colors are extremely small.

In the step S2005 in FIG. 9, the CPU 205a determines that there is a high possibility that an image defect will occur when the similar condition 1 or 2 described above is satisfied, and in the step S2009, the CPU 205a provides control as described below.

As for the similar condition 1, in the case of a continuous long job using only cyan and magenta, the CPU 205a produces outputs in colors that are not being used, that is, yellow and black whenever a predetermined number of sheets have been printed.

As for the similar condition 2, in the case of a continuous long job in which (C, M, Y, K)=(1%, 1%, 100%, 100%), the CPU 205a produces outputs in colors whose signal values are extremely small, that is, cyan and magenta whenever a predetermined number of sheets have been printed. It should be noted that although the predetermined striped pattern is taken for example as an image defect, control to cope with other abnormal events may be provided.

As described above, in the present embodiment, because determination criterion values for determining whether or not there is a high possibility that an abnormal event such as an image defect will occur in printed matter can be changed, notification of warning appropriate to user's intentions and usage environment can be realized.

Moreover, in the present embodiment, because not only settings of a job that define the status of the printing apparatus, the number of sheets to be printed, post-printing process, and so on but also job information obtained during processing by the RIP is used for determination, an accuracy with which to determine whether or not there is a high possibility that an abnormal event will occur in printed matter can be improved.

Further, in the present embodiment, because the user is notified that there is a high possibility that an image defect will occur, the user can recognize the necessity to perform inspection more carefully than usual.

Further, in the present embodiment, by notifying the user of a cause of a warning, the user may be prompted to avoid the cause in subsequent jobs, which can reduce frequency of occurrence of abnormal events.

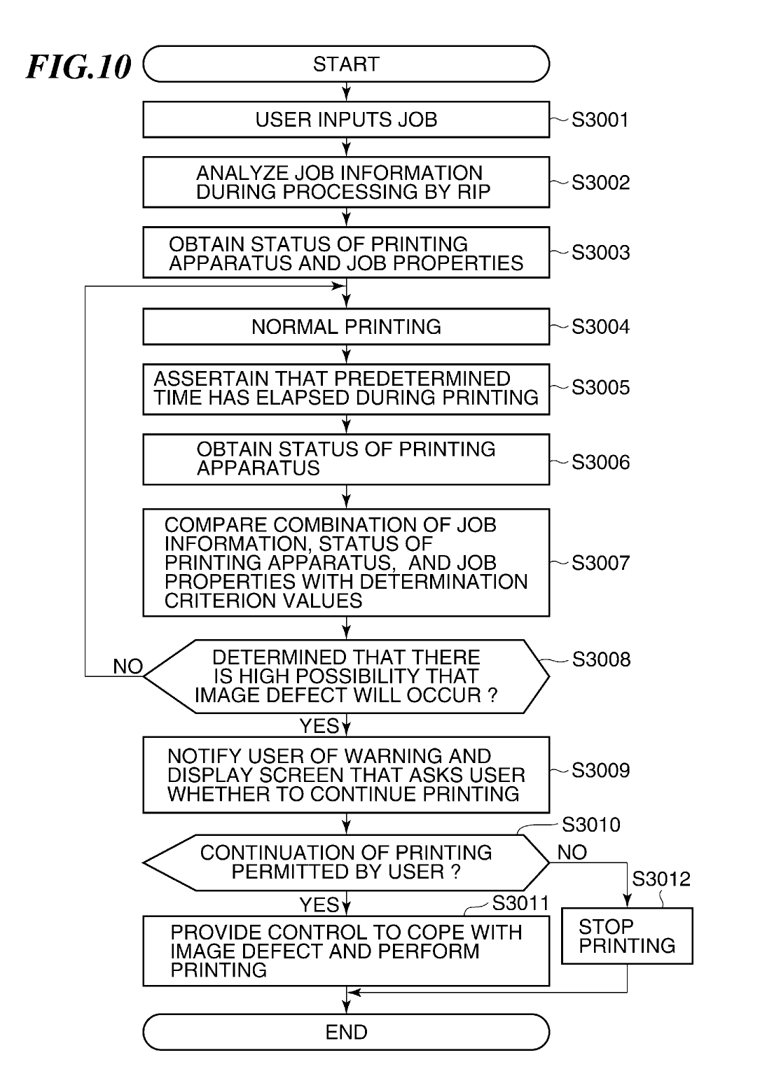

Referring next to FIG. 10, a description will be given of a printing apparatus which is a second embodiment of the present invention. It should be noted that elements and parts which overlap or correspond to those of the first embodiment described above will be described using the same figures and reference numerals. In the present embodiment, whether or not there is a high possibility that an image defect will occur is determined during a print job, not before input of a print job.

FIG. 10 is a flowchart useful in explaining an exemplary operation of the printing apparatus according to the present embodiment. Each of processes in FIG. 10 is executed by the CPU 205a of the control unit 205 in accordance with a control program stored in the ROM 207, the HDD 209, or the like of the printing apparatus 100 and loaded into the RAM 208.

In step S3001, the CPU 205a performs monitoring to check whether or not a printing request has been received. When a printing request has been received, the CPU 205a stores in the HDD 209 print data of a print job as an object to be executed, and proceeds to step S3002.

In the step S3002, during processing by the RIP, the CPU 205a analyzes job information to be inputted, and holds the same. The CPU 205a then proceeds to step S3003.

In the step S3003, the CPU 205a obtains a status of the printing apparatus 100 and settings of the job, and holds the obtained data. The CPU 205a then proceeds to step S3004.

In the step S3004, the CPU 205a starts normal printing, and proceeds to step S3005.

In the step S3005, the CPU 205a ascertains that a predetermined time period has elapsed before completion of the job, and proceeds to step S3006. It should be noted that a value of the predetermined time period may be uniquely determined, or arbitrarily set by the user.

In the step S3006, the CPU 205a obtains a status of the printing apparatus 100 again, and proceeds to step S3007.

In the step S3007, the CPU 205a compares a combination of the job information, the status of the printing apparatus 100, and job properties with determination criterion values, and proceeds to step S3008.

In the step S3008, the CPU 205a determines whether or not there is a high possibility that an image defect will occur based on the result of the comparison in the step S3007, and when determining that there is a high possibility that an image defect will occur, the CPU 205a proceeds to step S3009, and when not, the CPU 205a returns to the step S3004 where it continues normal printing.

In the step S3009, because it is determined that there is a high possibility that an image defect will occur, the CPU 205a displays the warning screen 8000 and the printing continuation permission dialogue 8001 shown in FIG. 8 in the touch panel portion 401, and proceeds to step S3010.

In the step S3010, the CPU 205a determines whether or not the user has permitted continuation of printing based on information on a user's operation on the printing continuation permission dialogue 8001, and when permitted, the CPU 205a proceeds to step S3011, and when not, the CPU 205a proceeds to step S3012.

In the step S3012, because the user has not permitted continuation of printing, the CPU 205a stops printing and terminates the process.

In the step S3011, because the user has permitted continuation of printing, the CPU 205a provides control to cope with an image defect, and after completion of printing, terminates the process. Other arrangements and operational effects are the same as those of the first embodiment described above.

In the first and second embodiments, when a job is inputted, it is determined whether or not an image defect will occur on printed matter resulting from the job as a result of execution of the job.

In a third embodiment described hereafter, the user is warned irrespective of a job when predetermined conditions are satisfied.

It should be noted that elements and parts which overlap or correspond to those of the first embodiment will be described using the same figures and reference numerals.

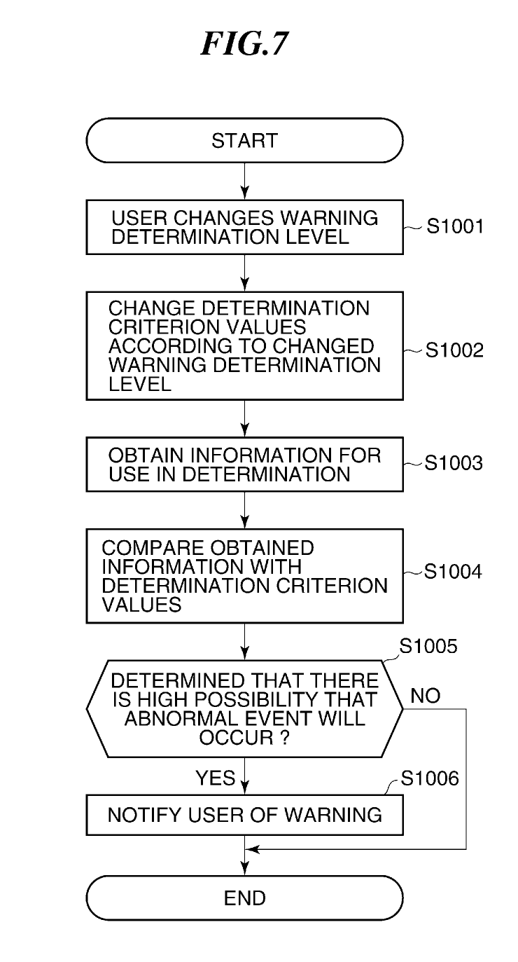

FIG. 7 is a flowchart useful in explaining an exemplary operation of a printing apparatus according to the present embodiment. Each of processes in FIG. 7 is executed by the CPU 205a of the control unit 205 in accordance with a control program stored in the ROM 2007, the HDD 209, or the like of the printing apparatus 100 and loaded into the RAM 208.

In step S1001, upon receiving a change of a warning determination level by the user, the CPU 205a changes determination criterion values according to the changed warning determination level, and causes the HDD 209 to hold them in step S1002.

In step S-1003, the CPU 205a obtains information for use in determination (a status of a printing apparatus such as a drum temperature) from the HOD 209, and in step S1004, the CPU 205a compares the obtained information and the determination criterion values with each other. In step S1005, the CPU 205a determines whether or not there is a high possibility that an abnormal event will occur, and when determining that there is a high possibility that an abnormal event will occur, the CPU 205a proceeds to step S1006 where it notifies the user that there is a high possibility that an abnormal event will occur. On the other hand, when not determining in the step S1005 that there is a high possibility that an abnormal event will occur, the CPU 205a terminates the process.

By the above described process, the user can be warned irrespective of a job when the predetermined conditions are satisfied, and also, the user can set the predetermined conditions.

Although this flowchart begins with the step S1001 in which the user changes the warning determination level, the CPU 205a may carry out the processes in the step S1003 and the subsequent steps at regular time intervals.

It should be noted that the present invention is not limited to the above described embodiments, but certain changes and modifications may be practiced without departing from the spirit and scope of the present invention.

For example, although in the above described embodiments, the operation display unit 204 of the printing apparatus 100 is taken for example as a user interface applied to the printing apparatus 100, the present invention is not limited to this. For example, it may be arranged such that the control unit 205 of the printing apparatus 100 executes processes in accordance with instructions from a user interface provided in an external apparatus such as a server or a client PC connected to the printing apparatus 100 via a network.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-149793 filed Jun. 24, 2009, which is hereby incorporated by reference herein in its entirety.

What is claimed is:

1. A job processing apparatus comprising:
a determination unit adapted to, when a job is to be executed, determine whether predetermined conditions will be satisfied by executing the job;
a notification unit adapted to, when said determination unit determines that the predetermined conditions will be satisfied by executing the job, notify a user that there is a high possibility that an image will not be correctly printed; and
a control unit adapted to change the predetermined conditions in accordance with an instruction received from the user.

2. A job processing apparatus as claimed in claim 1, wherein said control unit causes a display unit to display a screen for the user to select any level from among a plurality of levels, and when any level is selected from among the plurality of levels, changes the predetermined conditions to conditions corresponding to the selected level.

3. A job processing apparatus as claimed in claim 1, further comprising:
an obtaining unit adapted to obtain settings of the job; and
an identification unit adapted to identify a status of the job processing apparatus,
wherein based on the settings of the job obtained by said obtaining unit and the status of the job processing apparatus identified by said identification unit, said determination unit determines whether the predetermined conditions will be satisfied.

4. A job processing apparatus as claimed in claim 3, further comprising an analyzing unit adapted to analyze information on toner used for an image to be printed by executing the job,
wherein based on the information on the toner analyzed by said analyzing unit as well as the settings of the job obtained by said obtaining unit and the status of the job processing apparatus identified by said identification unit, said determination unit determines whether the predetermined conditions will be satisfied.

5. A job processing apparatus as claimed in claim 1, further comprising a receiving unit adapted to, when said determination unit determines that the predetermined conditions will be satisfied, receive an instruction indicative of whether to permit execution of the job from the user.

6. A control method for a job processing apparatus, comprising:
a determination step of, when a job is to be executed, determining whether predetermined conditions will be satisfied by executing the job;
a notification step of, when it is determined in said determination step that the predetermined conditions will be satisfied by executing the job, notifying a user that there is a high possibility that an image will not be correctly printed; and
a control step of changing the predetermined conditions in accordance with an instruction received from the user via an operation unit.

7. A non-transitory computer-readable storage medium storing a program for causing a computer to execute a control method for a job processing apparatus as claimed in claim 6.
